(19) United States
(12) Patent Application Publication
(10) Pub. No.: US 2026/0208963 A1
(43) Pub. Date: Jul. 23, 2026

(54) APPARATUS OF DELIVERING CONSIGNMENT

(71) Applicants: Hyundai Motor Company, Seoul (KR); Kia Corporation, Seoul (KR)

(72) Inventors: Kyungwook Lee, Hwaseong-si (KR); Junhwan Park, Hwaseong-si (KR); Pankeun Baek, Hwaseong-si (KR)

(21) Appl. No.: 19/220,805

(22) Filed: May 28, 2025

(30) Foreign Application Priority Data
Jan. 21, 2025 (KR) 10-2025-0008797

(51) Int. Cl. B65G 21/14; B65G 23/00

(52) U.S. Cl. CPC B65G 21/14; B65G 23/00; B65G 2812/02069; B65G 2812/02128

(57) ABSTRACT

An apparatus of delivering a consignment can include a housing, a delivery unit mounted in the housing to be movable in the length direction between a retracted state and a deployed state, and including conveyor shafts rotatably disposed on both sides in the length direction, and a conveyor belt extending across the conveyor shafts and rotatable between the conveyor shafts by rotation of the conveyor shafts, and a driving unit configured to provide power to the delivery unit to move the delivery unit in the length direction between the retracted state and the deployed state, and to provide power to at least one of the conveyor shafts to rotate the conveyor shafts, such that the consignment can be disposed on the conveyor belt and delivered to a target delivery point by rotation of the conveyor belt in one direction.

### CROSS-REFERENCE TO RELATED APPLICATIONS

This application claims priority to and the benefit of Korean Patent Application No. 10-2025-0008797 filed with the Korean Intellectual Property Office on Jan. 21, 2025, the entire contents of which are incorporated herein by reference.

### TECHNICAL FIELD

The present disclosure relates to an apparatus of delivering a consignment.

### BACKGROUND

Due to development of the Internet and rise of online shopping, the trend of purchasing goods online is increasing. The goods purchased online in this way may be delivered to buyers through courier services, and tens of thousands of couriers across the country work on-site to deliver these goods on time.

In particular, a courier may load a consignment onto a vehicle and travel the same along a road to a vicinity of a delivery location. Upon arriving at the delivery location, the courier may unload the consignment from the vehicle and transport the same directly to the delivery location. Accordingly, delivery time may increase and delivery workload may become excessive.

Such delivery difficulty may occur because the vehicle is unable to travel directly across the road to the delivery location. This delivery difficulty may be overcome if a delivery apparatus may be deployed from a vehicle on a road in the vicinity of the delivery location and transport the consignment to the delivery location, thereby automatically delivering the consignment to the delivery location.

The above information disclosed in this Background section is provided only to assist in a better understanding of the background of the present disclosure, and may therefore include information that is not a part of the prior art already publicly known, available, or in use.

### SUMMARY

The present disclosure relates to an apparatus of delivering a consignment, and more particularly, to an apparatus of delivering a consignment that delivers the consignment by deploying a delivery unit from a housing mounted in a vehicle or the like and transporting the consignment to a target delivery point.

An embodiment of the present disclosure can provide an apparatus of delivering a consignment that automatically delivers the consignment to a target delivery point by deploying a delivery unit from a housing mounted in a vehicle or the like and transporting the consignment to the target delivery point.

According to an embodiment, an apparatus of delivering a consignment can include: a housing forming a mounting space by having a length from one side to the other side in a length direction, a width from one side to the other side in a width direction perpendicular to the length direction, and a height in a height direction perpendicular to the length direction and the width direction, at least a portion of the other side of the housing being open in the length direction; a delivery unit mounted in the housing to be movable in the length direction between a retracted state and a deployed state, and including first and second conveyor shafts rotatably disposed on both sides in the length direction, and a conveyor belt extending across the first and second conveyor shafts and rotatable between the first and second conveyor shafts by rotation of the first and second conveyor shafts; and a driving unit configured to provide power to the delivery unit to move the delivery unit in the length direction between the retracted state and the deployed state, and to provide power to at least one of the first and second conveyor shafts to rotate the first and second conveyor shafts, wherein the consignment is disposed on the conveyor belt and delivered to a target delivery point by rotation of the conveyor belt in one direction.

A guide may be disposed on at least one of both sides of the housing in the width direction, the guide extending in the length direction, and the delivery unit may further include first and second rails disposed on both the sides of the delivery unit in the width direction, the first and second rails extending in the length direction, at least one of the first and second rails having a groove corresponding to the guide, and the guide being coupled to the groove to be movable in the length direction.

The first conveyor shaft may be rotatably connected to one end portions of the first and second rails in the length direction, and the second conveyor shaft may be rotatably connected to the other end portions of the first and second rails in the length direction.

The delivery unit may further include a support plate fixed to the first and second rails and covering a space between the first and second rails.

The driving unit may include a power source configured to provide the power while rotating in both directions, a first pinion rotary portion operably connected to the power source through a first power transmission member and fixedly mounted on a first pinion shaft, a second pinion rotary portion operably connected to a second power transmission member and fixedly mounted on a second pinion shaft, a first one-way power transmission member mounted on the first pinion shaft, operably connected to the first pinion shaft when the first pinion shaft rotates in one direction, and freely rotatable when the first pinion shaft rotates in a direction opposite to the one direction, a second one-way power transmission member mounted on the second pinion shaft, operably connected to the second pinion shaft when the second pinion shaft rotates in the direction opposite to the one direction, and freely rotatable when the second pinion shaft rotates in the one direction, a first rack portion fixedly disposed on the first rail and engaged with the first one-way power transmission member to receive the power from the first one-way power transmission member and move to the other side in the length direction when the first pinion shaft rotates in the one direction, and a second rack portion fixedly disposed on the second rail and engaged with the second one-way power transmission member to receive the power from the second one-way power transmission member and move to the one side in the length direction when the second pinion shaft rotates in the direction opposite to the one direction.

The driving unit may further include a power source shaft operably connected to the power source to receive the power from the power source, a first power source rotary portion mounted on one end portion of the power source shaft to rotate together with the power source shaft, and operably connected to the first pinion rotary portion through the first power transmission member, and a second power source rotary portion mounted on the other end portion of the power source shaft to rotate together with the power source shaft, and operably connected to the second pinion rotary portion through the second power transmission member.

The power source shaft may be operably connected to an output shaft of the power source through a power source output device.

The driving unit may further include a first conveyor rotary portion fixedly mounted on one end portion of the first conveyor shaft and rotatable by receiving the power through the first power transmission member, and a second conveyor rotary portion fixedly mounted on the other end portion of the first conveyor shaft and rotatable by receiving the power through the second power transmission member.

The first conveyor rotary portion may be operably connected to the first power transmission member depending on whether the first one-way power transmission member and the first rack portion are coupled to each other.

The first conveyor rotary portion may not be operably connected to the first power transmission member when the first one-way power transmission member and the first rack portion are coupled to each other, and may be operably connected to the first power transmission member when the first one-way power transmission member is separated from the first rack portion.

The first power source rotary portion may have a first pitch circle diameter (PCD)(PCD1), the first pinion rotary portion may have a second PCD (PCD2), the first rack portion may have a third PCD (PCD3), and the first conveyor rotary portion may have a fourth PCD (PCD4), wherein the first, second, third, and fourth PCDs (PCD1, PCD2, PCD3, PCD4) are set to satisfy the following:

$$\frac{PCD 2}{PCD 1} \times \frac{PCD 3}{PCD 4} = \frac{PCD 4}{PCD 1} .$$

The first and second power source rotary portions may each have a first pitch circle diameter (PCD)(PCD1), the first and second pinion rotary portions may each have a second PCD (PCD2), the first and second rack portions may each have a third PCD (PCD3), and the first and second conveyor rotary portions may each have a fourth PCD (PCD4), wherein the first, second, third, and fourth PCDs (PCD1, PCD2, PCD3, PCD4) are set to satisfy the following:

$$\frac{PCD 2}{PCD 1} \times \frac{PCD 3}{PCD 4} > \frac{PCD 4}{PCD 1} .$$

The first and second power source rotary portions may each have a first PCD (PCD1), the first and second pinion rotary portions may each have a second PCD (PCD2), the first and second rack portions may each have a third PCD (PCD3), and the first and second conveyor rotary portions may each have a fourth PCD (PCD4), wherein the first, second, third, and fourth PCDs (PCD1, PCD2, PCD3, PCD4) are set to satisfy the following:

$$\frac{PCD 2}{PCD 1} \times \frac{PCD 3}{PCD 4} < \frac{PCD 4}{PCD 1} .$$

A length of the first rack portion may be shorter than a length of the second rack portion.

The housing may include a first wall extending in the width direction and defining one surface in the length direction perpendicular to the width direction, a second wall defining one surface in the width direction, having one end connected to one end of the first wall in the length direction, and extending to the other side in the length direction, and a third wall defining the other surface in the width direction, having one end connected to the other end of the first wall in the length direction, and extending to the other side in the length direction, wherein the first, second, and third walls forms the mounting space.

The power source may be disposed outside the mounting space, first and second through holes may be formed in both side portions of the first wall, and the first and second power transmission members may pass through the first and second through holes to operatively connect the power source to the first and second pinion rotary portions, respectively.

The first conveyor shaft may be rotatable by receiving the power through the first and second conveyor rotary portions, and the second conveyor shaft may be rotatable by receiving the power through the conveyor belt.

The driving unit may further include at least one auxiliary rotary portion to transmit the power through the first and second power transmission members.

As set forth above, according to an embodiment of the present disclosure, the delivery unit may be deployed from the housing mounted in a vehicle or the like to a target delivery point, and the consignment may thus be automatically delivered to the target delivery point. Therefore, using an embodiment of the present disclosure, the delivery time and the delivery workload may be reduced.

In an embodiment of the present disclosure, the minimum power source may be used to make the delivery of the delivery unit, the rotation of the conveyor belt, and the retraction of the delivery unit possible.

In an embodiment of the present disclosure, the conveyor belt may not rotate while the delivery unit is deployed, thereby preventing the rotation of the conveyor belt caused by the load of the consignment without any separate braking device.

Advantages that may be acquired or predicted from the example embodiments of the present disclosure are disclosed directly or implicitly in the detailed description of the example embodiments of the present disclosure.

### BRIEF DESCRIPTION OF THE DRAWINGS

Example embodiments in the specification may be better understood by reference to the following description in connection with the accompanying drawings in which like reference numerals can refer to identical or functionally similar elements.

FIG. 1 is a perspective view of an apparatus of delivering a consignment according to an embodiment of the present disclosure, and schematically shows a state in which a delivery unit is retracted.

FIG. 2 is a perspective view of an apparatus of delivering a consignment according to an embodiment of the present disclosure, and schematically shows a state in which a delivery unit is deployed.

FIG. 3 is a schematic perspective view of an apparatus of delivering a consignment according to an embodiment of the present disclosure, without a portion of the housing.

FIG. 4 is a schematic perspective view of an apparatus of delivering a consignment according to an embodiment of the present disclosure, without a portion of a housing and a delivery unit.

FIG. 5 is a schematic perspective view of an apparatus of delivering a consignment according to an embodiment of the present disclosure, without a portion of a housing and a delivery unit.

FIG. 6 is a schematic plan view of a driving unit of an apparatus of delivering a consignment according to an embodiment of the present disclosure.

FIG. 7 is a schematic perspective view of a driving unit of an apparatus of delivering a consignment according to an embodiment of the present disclosure.

FIG. 8 schematically shows an operation of a driving unit included in an apparatus of delivering a consignment according to an embodiment of the present disclosure.

FIG. 9 is a schematic view showing lengths of first and second rack portions, according to an embodiment of the present disclosure.

It can be understood that the drawings referenced above are not necessarily drawn to scale, and can present a rather simplified representation of various features illustrating basic principles of some example embodiments of the present disclosure. For example, specific design features of an example embodiment of the present disclosure, including a specific dimension, orientation, position and shape, can be determined in part by the particular intended application and environment of use.

### DETAILED DESCRIPTION OF ILLUSTRATIVE EMBODIMENTS

Terms used herein are to describe example embodiments of the present disclosure, and are not intended to necessarily limit the present disclosure. A term of a single number used herein can be intended to include its plural number, unless the context clearly indicates otherwise. It can be understood that the terms “include” and/or “including”, when used in the specification, specify the presence of the recited features, integers, steps, operations, elements and/or components, and do not exclude the presence or addition of one or more of other features, integers, steps, operations, elements, elements, components and/or groups thereof. The term “and/or” used herein includes any one or all combinations of the associated listed items.

A term “vehicle”, “of a/the vehicle”, or other similar terms used in this specification may include general automobiles such as passenger vehicles, buses, trucks, and various commercial vehicles, which include sport utility vehicles (SUVs), ships including various boats and vessels, aircraft, tractors, drones, and robots, and may also include any object that may be moved by receiving power from a power source, for example. A “vehicle” or other similar terms used in this specification may be understood to include a hybrid powered vehicle, an electric powered vehicle, a plug-in hybrid powered vehicle, a hydrogen powered vehicle, and another alternative fuel (e.g., fuel derived from a source other than petroleum) powered vehicle, for example. As mentioned herein, a hybrid powered vehicle may include a vehicle that has two or more power sources, for example, a gasoline powered vehicle or an electric powered vehicle. A vehicle according to an embodiment of the present disclosure may include a vehicle that drives partially autonomously as well as a vehicle that drives fully autonomously or automatically, for example.

In this specification, the terms “operably coupled”, “operably connected”, or similar terms may indicate that two members are coupled or connected to each other to transmit and receive power.

It can be understood that one or more of methods described below or operations thereof may be executed by at least one controller. The term “controller” may refer to a hardware device including at least one memory and at least one processor. A memory may store program instructions, and a processor may be specifically programmed to execute such program instructions to perform one or more processes described below in more detail. A controller may control operations of units, modules, components, devices, or the like, as described herein. It can be understood that at least some of the methods described below may be executed by an apparatus including a controller in conjunction with one or more other components, as can be appreciated by those skilled in the art.

A controller of an example embodiment of the present disclosure may be implemented as at least one non-transitory computer-readable recording medium including executable program instructions executed by at least one processor. An example of the computer-readable recording medium may include a read only memory (ROM), a random access memory (RAM), a compact disk read only memory (CD-ROM), a magnetic tape, a floppy disk, a flash drive, a smart card, or an optical data storage device, and is not necessarily limited thereto, for example. A computer-readable recording medium may be distributed throughout a computer network, and the program instructions may thus be stored and executed in a distributed manner, for example, on a telematics server or a controller area network (CAN).

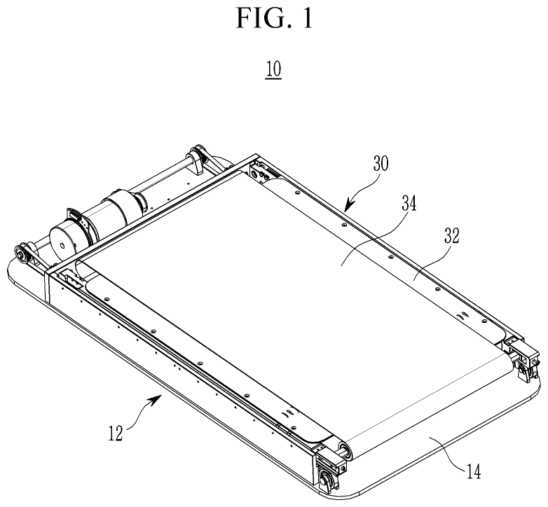

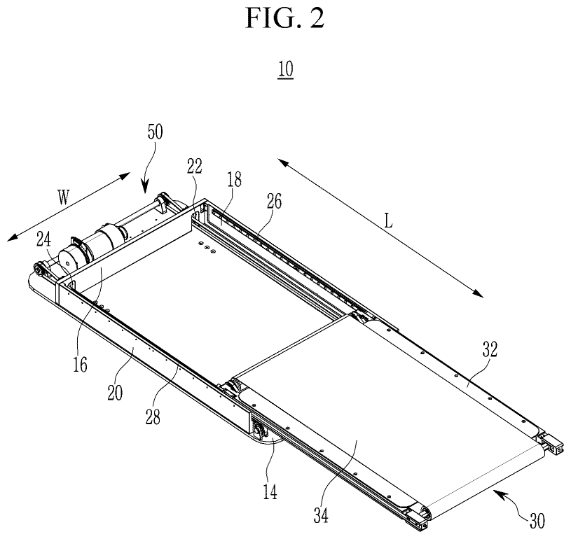

FIG. 1 is a perspective view of an apparatus of delivering a consignment according to an embodiment of the present disclosure, and schematically shows a state in which a delivery unit is retracted. FIG. 2 is a perspective view of an apparatus of delivering a consignment according to an embodiment of the present disclosure, and schematically shows a state in which a delivery unit is deployed.

As shown in FIGS. 1 and 2, an apparatus 10 of delivering a consignment according to an embodiment of the present disclosure may be mounted in a vehicle or a movable robot and may be retracted into the vehicle or the movable robot (see FIG. 1) or deployed from the vehicle or the movable robot (see FIG. 2). Either a single apparatus 10 of delivering the consignment or a plurality of apparatus 10 of delivering the consignment may be mounted in the vehicle or the movable robot. The apparatus 10 of delivering the consignment may include a housing 12, a delivery unit 30, and a driving unit.

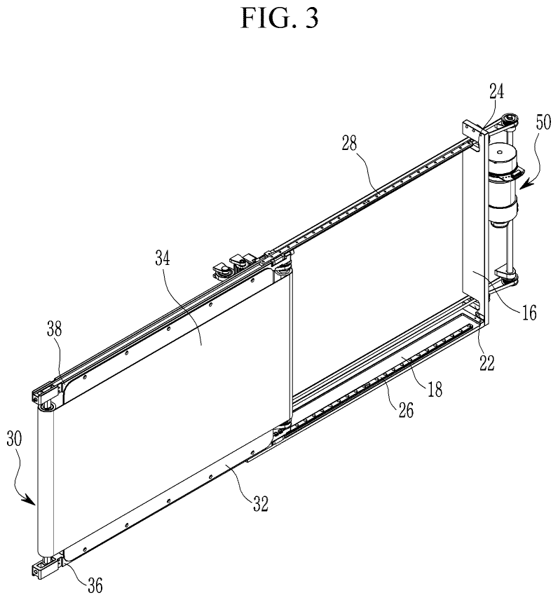

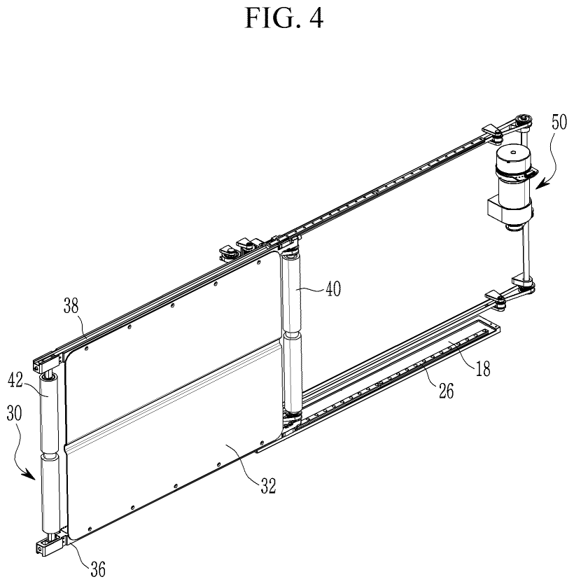

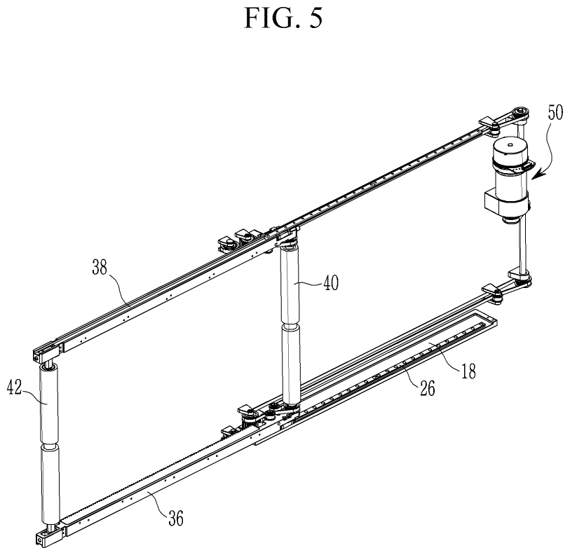

FIG. 3 is a schematic perspective view of an apparatus of delivering a consignment according to an embodiment of the present disclosure without a portion of a housing. FIG. 4 is a schematic perspective view of an apparatus of delivering a consignment according to an embodiment of the present disclosure without a portion of a housing and a delivery unit. FIG. 5 is a schematic perspective view of an apparatus of delivering a consignment according to an embodiment of the present disclosure without a portion of a housing and a delivery unit.

As shown in FIGS. 1 to 5, the housing 12 may be mounted at an appropriate position in a vehicle or a movable robot (e.g., a trunk floor surface, a truck bed, or the like of the vehicle), and the delivery unit 30 and the driving unit may be mounted in the housing 12. The housing 12 may have a generally rectangular hexahedron shape having an open top surface, and may not be necessarily limited thereto. As an example, the housing 12 may have a width in a width direction W, a length in a length direction L, and a height in a height direction to form a generally rectangular hexahedron mounting space, and have the open top surface. The housing 12 may include a base 14 and first, second, and third walls 16, 18, and 20.

The base 14 can provide a floor surface of the housing 12 and may be fixedly mounted at any appropriate position in a vehicle or a movable robot (e.g., a trunk floor surface, a truck bed, or the like of a vehicle). The base 14 may have a generally flat plate shape not to impede a movement of the delivery unit 30. The first, second, and third walls 16, 18, and 20 can each have a certain, selected, or predetermined height and may be mounted in a rectangular shape with one side open on the base 14.

The first wall 16 may be mounted on one side of the base 14 in the length direction L and may extend in the width direction W. First and second through holes 22 and 24 may be formed in both side portions of the first wall 16 in the width direction W.

The second wall 18 may be mounted on one side of the base 14 in the width direction W. One end of the second wall 18 in the length direction L may be connected to one end of the first wall 16 in the width direction W, and the second wall 18 may extend to the other side in the length direction L. A first guide 26 may be mounted on an inner surface of the second wall 18 (i.e., one surface facing the third wall 20), and the first guide 26 may extend in the length direction L to guide the movement of the delivery unit 30 in the length direction.

The third wall 20 may be mounted on the other side of the base 14 in the width direction W. One end of the third wall 20 in the length direction L may be connected to the other end of the first wall 16 in the width direction W, and the third wall 20 may extend to the other side in the length direction L. A second guide 28 may be mounted on an inner surface of the third wall 20 (i.e., one surface facing second wall 18), and the second guide 28 may extend in the length direction L to guide the movement of the delivery unit 30 in the length direction.

The other side of the housing 12 in the length direction L may be open, and the delivery unit 30 may be deployed or retracted in the length direction L through the opening. That is, the delivery unit 30 may be mounted in the housing 12 to be movable in the length direction L between a retracted state and a deployed state. The delivery unit 30 may include first and second rails 36 and 38, a support plate 32, first and second conveyor shafts 40 and 42, and a conveyor belt 34.

The first and second rails 36 and 38 may be disposed on both sides of the delivery unit 30 in the width direction W, and may extend in the length direction L. That is, the first rail 36 may be disposed one side of the delivery unit 30 in the width direction W, and may extend to the other side in the length direction L. The second rail 38 may be disposed on the other side of the delivery unit 30 in the width direction W, and may extend to the other side in the length direction L. The first and second rails 36 and 38 can be respectively facing the first and second guides 26 and 28 and may have grooves formed in their outer surfaces, thus allowing the first guide 26 to be inserted into the groove of the first rail 36 and the second guide 28 to be inserted into the groove of the second rail 38. Accordingly, the first and second guides 26 and 28 may guide the sliding movement of the first and second rails 36 and 38 in the length direction L, respectively.

The support plate 32 may be fixed to the first and second rails 36 and 38 and cover a space between the first and second rails 36 and 38. The support plate 32 may be fixed to the first and second rails 36 and 38 and movable in the length direction L together with the first and second rails 36 and 38. The support plate 32 may support the consignment or the like disposed thereon, and to this end, the support plate 32 may be made of a material having strength capable of supporting the consignment or the like, such as metal or plastic.

The first and second conveyor shafts 40 and 42 may be disposed on both sides of the delivery unit 30 in the length direction L and may extend in the width direction W. The first conveyor shaft 40 may have both ends rotatably connected to one end of the first rail 36 and one end of the second rail 38, and the second conveyor shaft 42 may have both ends rotatably connected to the other end of the first rail 36 and the other end of the second rail 38. The first and second conveyor shafts 40 and 42 may be movable in the length direction L together with the first and second rails 36 and 38, and may be rotatable on the first and second rails 36 and 38.

The conveyor belt 34 may extend across the first and second conveyor shafts 40 and 42 and can be movable in the length direction L together with the first and second conveyor shafts 40 and 42. The conveyor belt 34 may be rotatable between the first and second conveyor shafts 40 and 42 by rotation of the first and second conveyor shafts 40 and 42. In more detail, if the first and second conveyor shafts 40 and 42 do not rotate, the conveyor belt 34 may move in the length direction L together with the first and second conveyor shafts 40 and 42. That is, all the components included in the delivery unit 30 may move in the length direction L along the first and second guides 26 and 28. If the first and second conveyor shafts 40 and 42 rotate in one direction, a top portion of the conveyor belt 34 may move to the other side in the length direction L, and a bottom portion of the conveyor belt 34 may move to the one side in the length direction L. Accordingly, if the first and second conveyor shafts 40 and 42 rotate in the one direction, the consignment disposed on the conveyor belt 34 may be moved to the other side in the length direction L and delivered. In contrast, if the first and second conveyor shafts 40 and 42 rotate in a direction opposite to the one direction, the top portion of the conveyor belt 34 may move to the one side in the length direction L, and the bottom portion of the conveyor belt 34 may move to the other side in the length direction L. However, as an example, a pitch circle diameter (PCD) or a gear ratio of the components included in the driving unit may be set to prevent power transmission for rotating the first and second conveyor shafts 40 and 42 in the direction opposite to the one direction, and the setting of the PCD or the gear ratio may not be necessarily limited thereto. The PCD of any member may be related to the number of gear teeth of the corresponding member, and a ratio of the PCD of the first member to the PCD of the second member may correspond to a gear ratio of the first member to the second member.

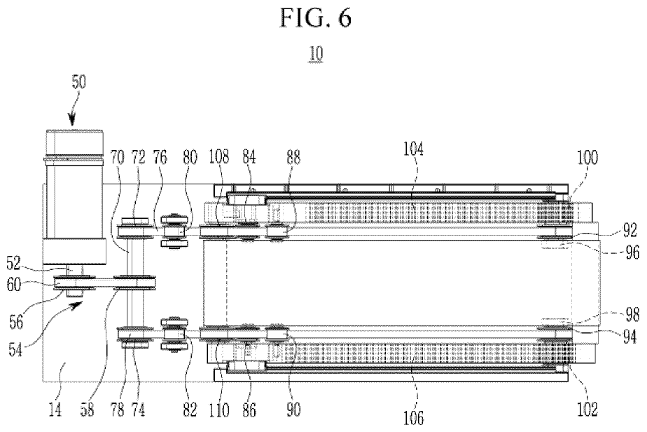

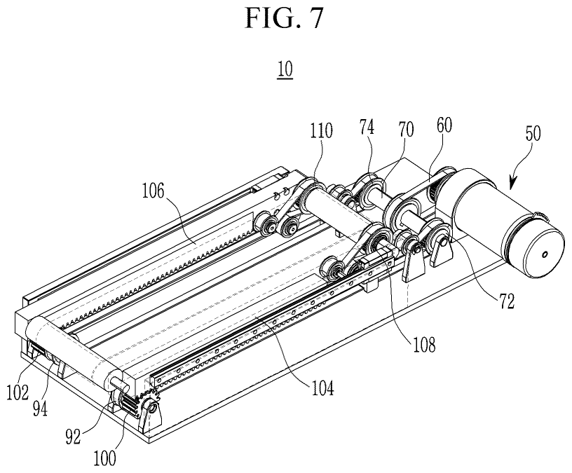

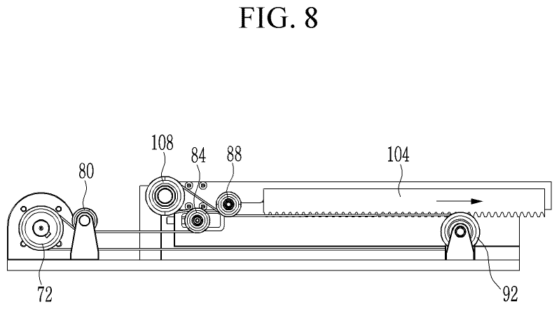

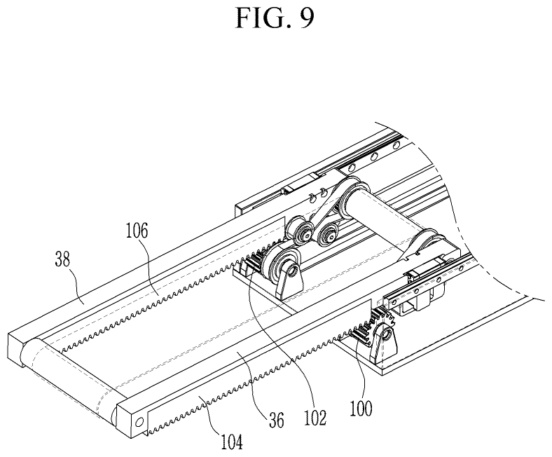

FIG. 6 is a schematic plan view of a driving unit of an apparatus of delivering a consignment according to an embodiment of the present disclosure. FIG. 7 is a schematic perspective view of a driving unit of an apparatus of delivering a consignment according to an embodiment of the present disclosure. FIG. 8 schematically shows an operation of a driving unit included in an apparatus of delivering a consignment according to an embodiment of the present disclosure. FIG. 9 is a schematic view showing lengths of first and second rack portions, according to an embodiment of the present disclosure.

As shown in FIGS. 1 to 9, the driving unit may be configured to provide power to the delivery unit 30 to move the delivery unit 30 in the length direction L between the retracted state and the deployed state. The driving unit may be configured to provide the power to the first and second conveyor shafts 40 and 42 of the delivery unit 30 to rotate the first and second conveyor shafts 40 and 42. The driving unit may include a power source 50, first and second power source rotary portions 72 and 74, first and second pinion rotary portions 92 and 94, first and second one-way power transmission members 100 and 102, first and second rack portions 104 and 106, and first and second conveyor rotary portions 108 and 110.

The power source 50 may provide the power to the delivery unit 30 to move the delivery unit 30 in the length direction L and rotate the first and second conveyor shafts 40 and 42. The power source 50 may be mounted on the base 14. As an example, the power source 50 may be mounted on the base 14 at one side from the first wall 16 in the length direction L, and a position of the power source 50 may not be necessarily limited thereto. The power source 50 may be an electric motor that receives current and rotates an output shaft 52, and a type of the power source 50 may not be necessarily limited thereto. As an example, the power source 50 may be a rotary shaft connected to a handle, and a user may hold the handle and rotate the rotary shaft to provide the power to the delivery unit 30. As another example, the power source 50 may be a hydraulic or pneumatic pump or the like, and may provide hydraulic or pneumatic power to the delivery unit 30. The power source 50 may be rotatable in both directions.

The power source 50 may transmit the power to a power source shaft 70 to thus transmit the power to the delivery unit 30 through the first and second power source rotary portions 72 and 74 fixedly mounted on the power source shaft 70. As an example, the output shaft 52 of the power source 50 may transmit the power to the power source shaft 70 through a power source output device 54. The power source output device 54 may include a power source driving unit 56 fixedly mounted on the output shaft 52 and rotating together with the output shaft 52, a power source driven unit 58 fixedly mounted on the power source shaft 70 and rotating together with the power source shaft 70, and a power source output transmission member 60 operatively connecting the power source driving unit 56 with the power source driven unit 58 (i.e., enabling power transmission therebetween). Each of the power source driving unit 56 and the power source driven unit 58 may be a pulley, the power source output transmission member 60 may be a belt, and types of the power source driving unit 56, the power source driven unit 58, and the power source output transmission member 60 may not be necessarily limited thereto. Each of the power source driving unit 56 and the power source driven unit 58 may be a gear, and the power source output transmission member 60 may be a chain or gear teeth. Each of the power source driving unit 56 and the power source driven unit 58 may be a friction wheel, and the power source output transmission member 60 may be a surface of the friction wheel. As another example, the output shaft 52 of the power source 50 may be formed integrally with the power source shaft 70 or may be directly connected to the power source shaft 70.

The first and second power source rotary portions 72 and 74 may be fixedly mounted on the power source shaft 70, which is operably connected to the power source 50 and capable of receiving the power from the power source 50, thereby rotating together with the power source shaft 70. The first and second power source rotary portions 72 and 74 may be mounted on both end portions of the power source shaft 70, respectively. In more detail, the first power source rotary portion 72 may have a first PCD and may be fixedly mounted on one end portion of the power source shaft 70 in the width direction W. The second power source rotary portion 74 may have the first PCD and may be fixedly mounted on the other end portion of the power source shaft 70 in the width direction W.

The first and second power source rotary portions 72 and 74 may rotate together with the power source shaft 70, and transmit the power from the power source 50 to the first and second pinion rotary portions 92 and 94 through first and second power transmission members 76 and 78. Each of the first and second power source rotary portions 72 and 74 may be mounted on the base 14 in the one side from the first wall 16 in the length direction L, and the first and second power transmission members 76 and 78 may extend to the other side in the length direction L through the first and second through holes 22 and 24 formed in the first wall 16, respectively. However, each position of the first and second power source rotary portions 72 and 74 and an arrangement of the first and second power transmission members 76 and 78 may not be necessarily limited thereto. In this specification, the first and second power source rotary portions 72 and 74 and the first and second pinion rotary portions 92 and 94 are exemplified as pulleys and the first and second power transmission members 76 and 78 are exemplified as belts. However, the first and second power source rotary portions 72 and 74, the first and second pinion rotary portions 92 and 94, and the first and second power transmission members 76 and 78 may not be necessarily limited to the pulleys and the belts, respectively. For example, the first and second power source rotary portions 72 and 74 and the first and second pinion rotary portions 92 and 94 may be gears, and the first and second power transmission members 76 and 78 may be chains.

The first and second pinion rotary portions 92 and 94 may each have the second PCD and may rotate by receiving the power from the power source 50 through the first and second power transmission members 76 and 78, respectively. The first and second pinion rotary portions 92 and 94 may be fixedly mounted on the first and second pinion shafts 96 and 98, respectively, and may rotate together with the first and second pinion shafts 96 and 98. In more detail, the first pinion shaft 96 may be rotatably mounted on the other side of the base 14 in the length direction L and on one side of the base 14 in the width direction W, and the first pinion rotary portion 92 may be fixedly mounted on the first pinion shaft 96 and may be operably connected to the first power transmission member 76. Accordingly, the first pinion rotary portion 92 may rotate by being operably connected to the first power source rotary portion 72 through the first power transmission member 76 to thus receive the power. The second pinion shaft 98 may be rotatably mounted on the other side of the base 14 in the length direction L and on the other side of the base 14 in the width direction W, and the second pinion rotary portion 94 may be fixedly mounted on the second pinion shaft 98 and operably connected to the second power transmission member 78. Accordingly, the second pinion rotary portion 94 may rotate by being operably connected to the second power source rotary portion 74 through the second power transmission member 78 to thus receive the power.

The first and second one-way power transmission members 100 and 102 may be mounted on the first and second pinion shafts 96 and 98, respectively, and may be operably and selectively connected to the first and second pinion shafts 96 and 98 based on the rotation direction of the first and second pinion shafts 96 and 98. In more detail, the first one-way power transmission member 100 may be mounted on the first pinion shaft 96, and operably connected to the first pinion shaft 96 when the first pinion shaft 96 rotates in the one direction, thereby receiving the power from the first pinion shaft 96. The first one-way power transmission member 100 may freely rotate while not being operably connected to the first pinion shaft 96 when the first pinion shaft 96 rotates in the direction opposite to the one direction. The second one-way power transmission member 102 may be mounted on the second pinion shaft 98, and operably connected to the second pinion shaft 98, thereby receiving the power from the second pinion shaft 98 when the second pinion shaft 98 rotates in the direction opposite to one direction. The second one-way power transmission member 102 may freely rotate while not being operably connected to the second pinion shaft 98 when the second pinion shaft 98 rotates in the one direction.

The first and second rack portions 104 and 106 may respectively be coupled to or formed integrally with bottom portions of the first and second rails 36 and 38, and may be movable in the length direction L together with the first and second rails 36 and 38. The first and second rack portions 104 and 106 may each have a third PCD and respectively be engaged with the first and second one-way power transmission members 100 and 102 to thus receive the power from the first and second one-way power transmission members 100 and 102, thereby moving in the length direction L. In more detail, the first rack portion 104 may be coupled to or formed integrally with the bottom portion of the first rail 36 and engaged with the first one-way power transmission member 100. When the first pinion shaft 96 rotates in the one direction, the first one-way power transmission member 100 may be operably connected to the first pinion shaft 96 to thus receive the power from the first pinion shaft 96, and the first rack portion 104 may receive the power from the first one-way power transmission member 100, thereby moving to the other side in the length direction L. Accordingly, when the first pinion shaft 96 rotates in the one direction, the delivery unit 30 may move to the other side in the length direction L to implement the deployed state. The second rack portion 106 may be coupled to or formed integrally with the bottom portion of the second rail 38 and engaged with the second one-way power transmission member 102. When the second pinion shaft 98 rotates in the direction opposite to the one direction, the second one-way power transmission member 102 may be operably connected to the second pinion shaft 98 to thus receive the power from the second pinion shaft 98, and the second rack portion 106 may receive the power from the second one-way power transmission member 102, thereby moving to the one side in the length direction L. Accordingly, when the second pinion shaft 98 rotates in the direction opposite to the one direction, the delivery unit 30 may move to the one side in the length direction L to implement the retracted state. In this specification, the first or second one-way power transmission member 100 or 102 and the first or second rack portion 104 or 106 are exemplified as a rack and a pinion gear coupled to each other, and types of the first and second one-way power transmission members 100 or 102 and the first and second rack portions 104 or 106 may not be necessarily limited thereto. As an example, the first or second one-way power transmission member 100 or 102 and the first or second rack portion 104 or 106 may be a gear and a friction wheel that may be in contact or coupled with each other to transmit power. As another example, at least one of the first and second one-way power transmission members 100 and 102 may be a clutch capable of direction control, such as a solenoid. In such example, the second one-way power transmission member and the second rack portion may not be used.

As shown in FIG. 9, a length of the first rack portion 104 may be shorter than a length of the second rack portion 106. Accordingly, in the deployed state, the second rack portion 106 may be engaged with the second one-way power transmission member 102, while the first rack portion 104 may be separated from the first one-way power transmission member 100. In this state, even if the first pinion shaft 96 continuously rotates in the one direction, the power from the first pinion shaft 96 may not be transmitted to the first rack portion 104. The second pinion shaft 98 may also rotate in the one direction. Accordingly, the second one-way power transmission member 102 may not be operably connected to the second pinion shaft 98, thus preventing the power from being transmitted to the second rack portion 106.

The first and second conveyor rotary portions 108 and 110 may be fixedly mounted on both end portions of the first conveyor shaft 40, respectively, and may rotate together with the first conveyor shaft 40. The first and second conveyor rotary portions 108 and 110 may each have a fourth PCD and receive the power by respectively being connected to the power source 50 through the first and second power transmission members 76 and 78. However, the first and second conveyor rotary portions 108 and 110 may not rotate due to not receiving the power from the power source 50 through the first and second power transmission members 76 and 78 when the first or second one-way power transmission member 100 or 102 and the first or second rack portion 104 or 106 are coupled to each other. In more detail, the first conveyor rotary portion 108 may be fixedly mounted on one end portion of the first conveyor shaft 40, the first conveyor rotary portion 108 may not rotate due to not receiving the power through the first power transmission member 76 when the first one-way power transmission member 100 and the first rack portion 104 are coupled to each other, and the first conveyor rotary portion 108 may rotate by receiving the power through the first power transmission member 76 when the first one-way power transmission member 100 and the first rack portion 104 are released from each other. The second conveyor rotary portion 110 may be fixedly mounted on the other end of the first conveyor shaft 40, the second conveyor rotary portion 110 may not rotate due to not receiving the power through the second power transmission member 78 when the second one-way power transmission member 102 and the second rack portion 106 are coupled to each other, and the second conveyor rotary portion 110 may rotate by receiving the power through the second power transmission member 78 when the second one-way power transmission member 102 and the second rack portion 106 are released from each other. To this end, the first, second, third, fourth PCDs (PCD1, PCD2, PCD3, and PCD4) may be set to satisfy Equation 1 below.

$$\frac{PCD 2}{PCD 1} \times \frac{PCD 3}{PCD 4} = \frac{PCD 4}{PCD 1} \qquad Equation 1$$

In this state, if the delivery apparatus 10 starts the delivery of the consignment, the power source 50 may rotate the power source shaft 70, and the first and second power source rotary portions 72 and 74 fixedly mounted on the power source shaft 70 may rotate the first and second pinion shafts 96 and 98 in the one direction through the first and second power transmission members 76 and 78 and the first and second pinion rotary portions 92 and 94. In this state, the first one-way power transmission member 100 may be operably connected to the first pinion shaft 96 and coupled to the first rack portion 104, and the first rack portion 104 may thus move to the other side in the length direction L. The first one-way power transmission member 100 may be coupled to the first rack portion 104, and accordingly, the first conveyor rotary portion 108 may not rotate due to not receiving the power from the first power transmission member 76. Accordingly, although the delivery unit 30 moves to the other side in the length direction L toward the target delivery point, the conveyor belt 34 may not rotate. The second pinion shaft 98 may rotate in the one direction, and accordingly, the second one-way power transmission member 102 may not be operably connected to the second pinion shaft 98. However, the delivery unit 30 may move to the other side in the length direction L, and the second one-way power transmission member 102 may be coupled to the second rack portion 106. Accordingly, the second conveyor rotary portion 110 may not rotate due to not receiving the power from the second power transmission member 78 although the second one-way power transmission member 102 also rotates in one direction.

When the power source 50 continuously rotates the first and second pinion shafts 96 and 98 in the one direction, the delivery unit 30 may move to the other side in the length direction L toward the target delivery point, and the first one-way power transmission member 100 may be separated from the first rack portion 104, while the second one-way power transmission member 102 may be continuously coupled to the second rack portion 106. The first one-way power transmission member 100 may be separated from the first rack portion 104, and the movement of the delivery unit 30 to the other side in the length direction L may thus be stopped, while the first conveyor rotary portion 108 may start to rotate by receiving the power from the first power transmission member 76. Accordingly, the first and second conveyor shafts 40 and 42 and the conveyor belt 34 may rotate in the one direction, and the top portion of the conveyor belt 34 may move to the other side in the length direction L. Accordingly, the consignment disposed on the top portion of the conveyor belt 34 may move to the other side in the length direction L together with the top portion of the conveyor belt 34 toward the target delivery point to thus be disposed at the target delivery point. When the power source 50 rotates the first and second pinion shafts 96 and 98 continuously in the one direction, all the consignments may be delivered to the target delivery point and the conveyor belt 34 may continuously rotate in the one direction.

When the movement of the delivery unit 30 to the other side in the length direction L stops, the rotation of the second one-way power transmission member 102 and the movement of the second rack portion 106 may also stop.

When the delivery of the consignment is completed, the delivery apparatus 10 may retract the delivery unit 30. That is, the power source 50 may rotate the first and second pinion shafts 96 and 98 in the direction opposite to the one direction through the power source shaft 70, the first and second power source rotary portions 72 and 74, the first and second power transmission members 76 and 78, and the first and second pinion rotary portions 92 and 94. In this state, the second one-way power transmission member 102 may be operably connected to the second pinion shaft 98 and coupled to the second rack portion 106, and the second rack portion 106 may thus move to the one side in the length direction L. The second one-way power transmission member 102 may be coupled to the second rack portion 106, and accordingly, the second conveyor rotary portion 110 may not rotate due to not receiving the power from the second power transmission member 78. Accordingly, although the delivery unit 30 moves to the one side in the length direction L toward the retracted position, the conveyor belt 34 may not rotate. The first pinion shaft 96 may rotate in the direction opposite to one direction, and accordingly, the first one-way power transmission member 100 may not be operably connected to the first pinion shaft 96. However, the delivery unit 30 may move to the one side in the length direction L, and the first one-way power transmission member 100 may be coupled to the first rack portion 104. Accordingly, the first conveyor rotary portion 108 may not rotate due to not receiving the power from the first power transmission member 100 although the first one-way power transmission member 100 also rotates in the one direction.

However, a relationship among the first, second, third, and fourth PCDs (PCD1, PCD2, PCD3, and PCD4) may not be necessarily limited to Equation 1.

As an example, the first, second, third, and fourth PCDs (PCD1, PCD2, PCD3, and PCD4) may be set to satisfy Equation 2 below.

$$\frac{PCD 2}{PCD 1} \times \frac{PCD 3}{PCD 4} > \frac{PCD 4}{PCD 1} \qquad Equation 2$$

In this state, when the power source 50 rotates the first and second pinion shafts 96 and 98 in the one direction through the power source shaft 70, the first and second power source rotary portions 72 and 74, the first and second power transmission members 76 and 78, and the first and second pinion rotary portions 92 and 94, the first one-way power transmission member 100 may be operably connected to the first pinion shaft 96 and coupled to the first rack portion 104, and accordingly, the first rack portion 104 may move to the other side in the length direction L, and the first conveyor rotary portion 108 may rotate in the one direction by receiving the power from the first power transmission member 76. That is, the delivery unit 30 may move to the other side in the length direction L toward the target delivery point, the conveyor belt 34 may rotate in the one direction, and the top portion of the conveyor belt 34 may also move to the other side in the length direction L. When the first one-way power transmission member 100 is separated from the first rack portion 104, the conveyor belt 34 may rotate in the one direction at an increased rotational speed, and the top portion of the conveyor belt 34 may also move to the other side in the length direction L at the increased speed.

The second pinion shaft 98 may rotate in the one direction, and accordingly, the second one-way power transmission member 102 may not be operably connected to the second pinion shaft 98. However, the delivery unit 30 may move to the other side in the length direction L and the second one-way power transmission member 102 may be coupled to the second rack portion 106. Accordingly, the second one-way power transmission member 102 may also rotate in the one direction and the second conveyor rotary portion 110 may rotate in the one direction.

When the power source 50 rotates the first and second pinion shafts 96 and 98 in the direction opposite to one direction through the power source shaft 70, the first and second power source rotary portions 72 and 74, the first and second power transmission members 76 and 78, and the first and second pinion rotary portions 92 and 94, the second one-way power transmission member 102 may be operably connected to the second pinion shaft 98 and coupled to the second rack portion 106. Accordingly, the second rack portion 106 may move to the one side in the length direction L, and the second conveyor rotary portion 110 may rotate in the direction opposite to one direction by receiving power from the second power transmission member 78. That is, the delivery unit 30 may move to the one side in the length direction L toward the retracted position, the conveyor belt 34 may rotate in the direction opposite to one direction, and the top portion of the conveyor belt 34 may also move to the one side in the length direction L.

The first pinion shaft 96 may rotate in the direction opposite to one direction, and accordingly, the first one-way power transmission member 100 may not be operably connected to the first pinion shaft 96. However, the delivery unit 30 may move to the one side in the length direction L and the first one-way power transmission member 100 may be coupled to the first rack portion 104. Accordingly, the first one-way power transmission member 100 may also rotate in the direction opposite to one direction and the first conveyor rotary portion 108 may rotate in the direction opposite to one direction.

Alternatively, the first, second, third, and fourth PCDs (PCD1, PCD2, PCD3, and PCD4) may be set to satisfy Equation 3 below.

$$\frac{PCD 2}{PCD 1} \times \frac{PCD 3}{PCD 4} < \frac{PCD 4}{PCD 1} \qquad Equation 3$$

In this state, when the power source 50 rotates the first and second pinion shafts 96 and 98 in the one direction through the power source shaft 70, the first and second power source rotary portions 72 and 74, the first and second power transmission members 76 and 78, and the first and second pinion rotary portions 92 and 94, the first one-way power transmission member 100 may be operably connected to the first pinion shaft 96 and coupled to the first rack portion 104, and accordingly, the first rack portion 104 may move to the other side in the length direction L, and the first conveyor rotary portion 108 may rotate in the direction opposite to the one direction by receiving the power from the first power transmission member 76. That is, the delivery unit 30 may move to the other side in the length direction L toward the target delivery point, the conveyor belt 34 may rotate in the direction opposite to one direction, and the top portion of the conveyor belt 34 may also move to the one side in the length direction L. When the first one-way power transmission member 100 is separated from the first rack portion 104, the conveyor belt 34 may rotate in the one direction at an increased rotational speed, and the top portion of the conveyor belt 34 may also move to the other side in the length direction L at the increased speed.

The second pinion shaft 98 may rotate in the one direction, and accordingly, the second one-way power transmission member 102 may not be operably connected to the second pinion shaft 98. However, the delivery unit 30 may move to the other side in the length direction L and the second one-way power transmission member 102 may be coupled to the second rack portion 106. Accordingly, the second one-way power transmission member 102 may also rotate in the one direction and the second conveyor rotary portion 110 may rotate in the direction opposite to one direction.

When the power source 50 rotates the first and second pinion shafts 96 and 98 in the direction opposite to one direction through the power source shaft 70, the first and second power source rotary portions 72 and 74, the first and second power transmission members 76 and 78, and the first and second pinion rotary portions 92 and 94, the second one-way power transmission member 102 may be operably connected to the second pinion shaft 98 and coupled to the second rack portion 106, and accordingly, the second rack portion 106 may move to the one side in the length direction L, and the second conveyor rotary portion 110 may rotate in the one direction by receiving the power from the second power transmission member 78. That is, the delivery unit 30 may move to the one side in the length direction L toward the retracted position, the conveyor belt 34 may rotate in the one direction, and the top portion of the conveyor belt 34 may also move to the other side in the length direction L.

The first pinion shaft 96 may rotate in the direction opposite to the one direction, and accordingly, the first one-way power transmission member 100 may not be operably connected to the first pinion shaft 96. However, the delivery unit 30 may move to the one side in the length direction L and the first one-way power transmission member 100 may be coupled to the first rack portion 104. Accordingly, the first one-way power transmission member 100 may also rotate in the direction opposite to the one direction and the first conveyor rotary portion 108 may rotate in the one direction.

The driving unit may further include first, second, third, fourth, fifth, and sixth auxiliary rotary portions 80, 82, 84, 86, 88, and 90. The first, second, third, fourth, fifth, and sixth auxiliary rotary portions 80, 82, 84, 86, 88, and 90 may be connected to the first and second power transmission members 76 and 78 to thus smoothly transmit the power through the first and second power transmission members 76 and 78, or adjust the rotation direction of the first and second power source rotary portions 72 and 74, the first and second pinion rotary portions 92 and 94, the first and second one-way power transmission members 100 and 102, and the first and second conveyor rotary portions 108 and 110. For example, the first and third auxiliary rotary portions 80 and 84 may each be disposed between the first power source rotary portion 72 and the first conveyor rotary portion 108, and the second and fourth auxiliary rotary portions 82 and 86 may each be disposed between the second power source rotary portion 74 and the second conveyor rotary portion 110. The fifth auxiliary rotary portion 88 may be disposed between the first pinion rotary portion 92 and the first conveyor rotary portion 108, and the sixth auxiliary rotary portion 90 may be disposed between the second pinion rotary portion 94 and the second conveyor rotary portion 110. However, whether the auxiliary rotary portion is used, a position of the auxiliary rotary portion, and the number of auxiliary rotary portions are not necessarily limited to those exemplified, and a designer may appropriately set whether the auxiliary rotary portion is used, the position of the auxiliary rotary portion, and the number of auxiliary rotary portions based on the required specification and required power of the delivery apparatus 10.

Although the specific example embodiments of the present disclosure have been described hereinabove, the scopes of the present disclosure are not necessarily limited thereto and can include modifications and equivalents that may be easily made or recognized by those skilled in the art to which the present disclosure pertains.

What is claimed is:

1. An apparatus of delivering a consignment, comprising:
a housing having a mounting space by having a length from a first length side to a second length side in a length direction, and a width from a first width side to a second width side in a width direction perpendicular to the length direction, at least a portion of the second length side of the housing being open in the length direction;
a delivery unit mounted in the housing to be movable in the length direction between a retracted state and a deployed state, and wherein the delivery unit comprises:
first and second conveyor shafts rotatably disposed on both the first length side and the second length side in the length direction, and
a conveyor belt extending across the first and second conveyor shafts and rotatable between the first and second conveyor shafts by rotation of the first and second conveyor shafts; and
a driving unit configured to provide a power to the delivery unit to move the delivery unit in the length direction between the retracted state and the deployed state, and to provide the power to at least one of the first and second conveyor shafts to rotate the first and second conveyor shafts,
wherein the apparatus is configured such that the consignment can be disposed on the conveyor belt and delivered to a target delivery point by rotation of the conveyor belt in a first rotation direction.

2. The apparatus of claim 1, further comprising:
a guide disposed on at least one of the first width side and the second width side of the housing in the width direction, the guide extending in the length direction, and
wherein the delivery unit further comprises first and second rails disposed on both the first width side and the second width side of the delivery unit in the width direction, the first and second rails extending in the length direction, at least one of the first and second rails having a groove corresponding to the guide, and the guide being coupled to the groove to be movable in the length direction.

3. The apparatus of claim 2, wherein the first conveyor shaft is rotatably connected to first end portions of the first and second rails at the first length side in the length direction, and wherein the second conveyor shaft is rotatably connected to second end portions of the first and second rails at the second length side in the length direction.

4. The apparatus of claim 2, wherein the delivery unit further comprises a support plate fixed to the first and second rails and covering a space between the first and second rails.

5. The apparatus of claim 2, wherein the driving unit comprises:
a power source configured to provide the power while rotating in both power-source rotation directions;
a first power transmission member;
a first pinion shaft;
a first pinion rotary portion operably connected to the power source through the first power transmission member and fixedly mounted on the first pinion shaft;
a second power transmission member;
a second pinion shaft;
a second pinion rotary portion operably connected to the second power transmission member and fixedly mounted on the second pinion shaft;
a first one-way power transmission member mounted on the first pinion shaft, wherein the first one-way power transmission member is operably connected to the first pinion shaft based on the first pinion shaft being rotated in the first rotation direction, and wherein the first one-way power transmission member is freely rotatable relative to the first pinion shaft based on the first pinion shaft being rotated in a second rotation direction opposite to the first rotation direction;
a second one-way power transmission member mounted on the second pinion shaft, wherein the second one-way power transmission member is operably connected to the second pinion shaft based on the second pinion shaft being rotated in the second rotation direction opposite to the first rotation direction, and wherein the second one-way power transmission member is freely rotatable based on the second pinion shaft being rotated in the first rotation direction;
a first rack portion fixedly disposed on the first rail and engaged with the first one-way power transmission member in a first configuration to receive the power from the first one-way power transmission member and move to the second length side in the length direction based on the first pinion shaft being rotated in the first rotation direction; and
a second rack portion fixedly disposed on the second rail and engaged with the second one-way power transmission member in a second configuration to receive the power from the second one-way power transmission member and move to the first length side in the length direction based on the second pinion shaft being rotated in the second rotation direction opposite to the first rotation direction.

6. The apparatus of claim 5, wherein the driving unit further comprises:
a power source shaft operably connected to the power source and configured to receive the power from the power source;
a first power source rotary portion mounted on a first power-source-shaft end portion of the power source shaft to be rotatable together with the power source shaft, and wherein the first power source rotary portion is operably connected to the first pinion rotary portion through the first power transmission member; and
a second power source rotary portion mounted on a second power-source-shaft end portion of the power source shaft to be rotatable together with the power source shaft, and wherein the second power source rotary portion is operably connected to the second pinion rotary portion through the second power transmission member.

7. The apparatus of claim 6, wherein the power source shaft is operably connected to an output shaft of the power source through a power source output device.

8. The apparatus of claim 5, wherein the driving unit further comprises:
a first conveyor rotary portion fixedly mounted on a first-conveyor-shaft first end portion of the first conveyor shaft and configured to be rotatable by receiving the power through the first power transmission member; and
a second conveyor rotary portion fixedly mounted on a first-conveyor-shaft second end portion of the first conveyor shaft and configured to be rotatable by receiving the power through the second power transmission member.

9. The apparatus of claim 8, wherein the first conveyor rotary portion is operably connected to the first power transmission member depending on whether the first one-way power transmission member and the first rack portion are coupled to each other.

10. The apparatus of claim 9, wherein the first conveyor rotary portion is not operably connected to the first power transmission member based on the first one-way power transmission member and the first rack portion being coupled to each other, and wherein the first conveyor rotary portion is operably connected to the first power transmission member based on the first one-way power transmission member being separated from the first rack portion.

11. The apparatus of claim 10, wherein a first power source rotary portion has a first pitch circle diameter PCD1, the first pinion rotary portion has a second pitch circle diameter PCD2, the first rack portion has a third pitch circle diameter PCD3, and the first conveyor rotary portion has a fourth pitch circle diameter PCD4, and
wherein the first pitch circle diameter PCD1, the second pitch circle diameter PCD2, the third pitch circle diameter PCD3, and the fourth pitch circle diameter PCD4 are set to satisfy the following:
$$\frac{PCD 2}{PCD 1} \times \frac{PCD 3}{PCD 4} = \frac{PCD 4}{PCD 1} .$$

12. The apparatus of claim 8, wherein first and second power source rotary portions each have a first pitch circle diameter PCD1, the first and second pinion rotary portions each have a second pitch circle diameter PCD2, the first and second rack portions each have a third pitch circle diameter PCD3, and the first and second conveyor rotary portions each have a fourth pitch circle diameter PCD4, and
wherein the first pitch circle diameter PCD1, the second pitch circle diameter PCD2, the third pitch circle diameter PCD3, and the fourth pitch circle diameter PCD4 are set to satisfy the following:
$$\frac{PCD 2}{PCD 1} \times \frac{PCD 3}{PCD 4} = \frac{PCD 4}{PCD 1} .$$

13. The apparatus of claim 8, wherein first and second power source rotary portions each have a first pitch circle diameter PCD1, the first and second pinion rotary portions each have a second pitch circle diameter PCD2, the first and second rack portions each have a third pitch circle diameter PCD3, and the first and second conveyor rotary portions each have a fourth pitch circle diameter PCD4, and
wherein the first pitch circle diameter PCD1, the second pitch circle diameter PCD2, the third pitch circle diameter PCD3, and the fourth pitch circle diameter PCD4 are set to satisfy the following:
$$\frac{PCD 2}{PCD 1} \times \frac{PCD 3}{PCD 4} < \frac{PCD 4}{PCD 1} .$$

14. The apparatus of claim 5, wherein a first-rack-portion length of the first rack portion is shorter than a second-rack-portion length of the second rack portion.

15. The apparatus of claim 5, wherein the housing comprises:
a first wall extending in the width direction and having a first surface in the length direction perpendicular to the width direction;
a second wall having a second surface in the width direction, having a first second-wall end connected to a first first-wall end of the first wall in the length direction, and extending to the second length side in the length direction; and
a third wall having a third surface in the width direction, having a first third-wall end connected to a second first-wall end of the first wall in the length direction, and extending to the second length side in the length direction, wherein the first, second, and third walls partially bound the mounting space.

16. The apparatus of claim 15, wherein the power source is disposed outside the mounting space, and
wherein first and second through holes are formed in both side portions of the first wall, and wherein the first and second power transmission members pass through the first and second through holes to operatively connect the power source to the first and second pinion rotary portions, respectively.

17. The apparatus of claim 8, wherein the first conveyor shaft is configured to be rotatable by receiving the power through the first and second conveyor rotary portions, and wherein the second conveyor shaft is configured to be rotatable by receiving the power through the conveyor belt.

18. The apparatus of claim 8, wherein the driving unit further comprises an auxiliary rotary portion configured to transmit the power through the first and second power transmission members.

19. An apparatus of a vehicle for delivering a consignment, comprising:
a housing having a length direction, the housing being configured to be coupled to the vehicle;
a delivery system movably coupled to the housing to be movable in the length direction relative to the housing between a retracted state and a deployed state, wherein the delivery system comprises:
a first conveyor shaft,
a second conveyer shaft spaced apart from the first conveyor shaft in the length direction, and
a conveyor belt looping around the first conveyor shaft and the second conveyor shaft such that the conveyor belt is configured to rotate with rotation of the first conveyor shaft and the second conveyor shaft; and
a driving system having a single power source configured to provide a rotational power to the delivery system to move the delivery system in the length direction between the retracted state and the deployed state relative to the housing, and to rotate at least the first conveyor shaft to cause the conveyor belt to rotate with the rotational power, such that the consignment can be disposed on the conveyor belt and delivered to a target delivery point by rotating the conveyor belt in a first rotation direction.

20. A vehicle comprising:
an apparatus for delivering a consignment, wherein the apparatus comprises:
a housing having a length direction, the housing being coupled to the vehicle,
a delivery system movably coupled to the housing to be movable in the length direction relative to the housing between a retracted state and a deployed state, wherein the delivery system comprises:
a first conveyor shaft,
a second conveyer shaft spaced apart from the first conveyor shaft in the length direction, and
a conveyor belt looping around the first conveyor shaft and the second conveyor shaft such that the conveyor belt is configured to rotate with rotation of the first conveyor shaft and the second conveyor shaft, and
a driving system having a single power source configured to provide a rotational power to the delivery system to move the delivery system in the length direction between the retracted state and the deployed state relative to the housing, and to rotate at least the first conveyor shaft to cause the conveyor belt to rotate with the rotational power, such that the consignment can be disposed on the conveyor belt and delivered to a target delivery point by rotating the conveyor belt in a first rotation direction.
